(19) United States
(12) Patent Application Publication
(10) Pub. No.: US 2006/0279769 A1
(43) Pub. Date: Dec. 14, 2006

(54) System and method for secure printing of a transaction document at a remote location

(75) Inventors: Keith D. Ludwig, New Fields, NH (US); Gregory E. Park, Stratham, NH (US)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH (US)

(21) Appl. No.: 11/152,450

(22) Filed: Jun. 14, 2005

(51) Int. Cl. G06F 3/12

(52) U.S. Cl. 358/1.15; 358/540

(57) ABSTRACT

A system for generating a document at a print system under the control of a remote client comprises a document image template, a print command object, and a print control executable. The document template comprising a document image and a plurality of data fields. The print command object receives a content message which comprises a plurality of data elements. The print command object creates a binary object representing a print command file. The print command file includes data and print system commands representing the document image template with the data fields populated with data elements from the content message. The binary object is provided to the remote client. The print control executable, operating on the remote client, receives the binary object into volatile memory send passes the print command file to the print system for document generation.

### TECHNICAL FIELD

The present invention relates to a system and method for secure document delivery to a remote location, and more particularly, to a secure system and method for the transport of a transaction document to a remote system.

### BACKGROUND OF THE INVENTION

Businesses have long used software systems for recording their commercial interactions with customers, vendors, financial institutions, and other third parties. Traditionally, transactional information has been exchanged between two businesses using printed documents such as purchase orders, invoices, and other similar documents.

The software systems of a first business generate and print such a document, the document is delivered to the recipient business, and an agent of the recipient business manually enters information from the document into its software systems.

Checks and other negotiable instruments are a special type of transaction document in that its clearing through banking systems result in the transfer of funds from a payor's bank account to a payee's bank account. While no check printing system is entirely “error proof” of “fraud proof”, security has always been an important aspect of the software systems which print checks to reduce erroneous and/or fraudulent check printing.

Early check printing systems received payment information from an accounting system and printed the payment information onto pre-printed check stock. Security in such systems is maintained by: i) controlling access to the blank check stock; and ii) using log-on authentication systems to control access to the software.

More recently developed laser check printing systems and MICR toner enable printing of checks on blank stock. Security in a laser check printing systems is maintained by using log-on authentication systems to control access to the software and encryption of payment data in the databases managed by the laser check printing system. I

In a large business enterprise, it is desirable to be able to control check printing from a single location, such as corporate headquarters, but to enable the physical check documents to be printed at remote locations. This produces security challenges not addressed by known laser check printing and document delivery systems.

First, a portion of a laser check printing system's security exists in that the software which generates the check operates on the same computer on which the print spooler exists. As such, once a print formatted object representing the check is generated, it is transferred directly to the print spooler without ever being saved to the hard drive of the computer. This reduces the ability to accidentally or intentionally reprint the same check document a second time.

A problem with attempting to implement such technology for printing at remote locations requires distribution of the laser check printing software to each remote location, granting access to the software to personal at each location, and transferring payment files to each remote location for the operator to: decrypt the file, load into the check printing software; and initiate local printing of the checks. Such a system fails to maintain centralized control of check printing.

Another potential solution would include using known laser check printing solution to “print” checks at a centralized location to a portable document file rather than to hard copy. Traditional file delivery systems such as email, FTP, and other similar protocols may be used for transferring the portable document file from the computer on which the laser check system is resident to a remote computer system at which the checks can then be printed. This system also has several draw backs. First, traditional file delivery systems such as email and FTP store a copy of the file on the hard drive of the sending computer and on the hard drive of the receiving computer—making such file available for accidental or intentional reprinting of the documents. Adding password access control to each portable document file is cumbersome at best.

U.S. Pat. No. 6,615,234 to Adamske et al. discloses a server based document delivery system which can be used for transferring a document directly to a remote print spooler server over a network. The server of Adamske et al. includes a plurality of software applications. Each software application receives information content in as file in one of a plurality of file formats which the software application is capable of opening. The software application is used to generate an image of a document and the server generates a document file the from for delivery to a print spooler server for printing. The document file delivered to the print spooler is a PostScript file. While such a system could be useful for printing checks on a remote printer, it has drawbacks.

First, to be used for printing checks, the server must have application level software which is capable of opening the electronic file passed from the laser check printing software and “printing” the checks. This can lead cumbersome duplicate installation and duplicate maintenance issues.

Secondly, the timing of when the checks are printed on the remote computer is under the control of the operator transferring the electronic checks to the server and the server generating the Post Script for transfer to the print spooler. As such, security of the printer at the time the checks are to be printed must be coordinated between the operator of the centralized laser check printing software and those with control over the remote printer.

A separate field of technology known as web services is being developed to support platform independent processing calls over the Internet. Web Services are data processing services (referred to as methods) which are offered by a servicing application to a requesting application operating on a remote system.

The system offering the web services to requesting systems publishes a Web Service Description Language (WSDL) document which is an Extensible Markup Language (XML) document in compliance with the WSDL protocol that describes the web service. The description of the web service may include the name of the web service, the tasks that it performs, the URL to which the method requests may be sent, and the XML structure and parameters required in a method request.

To obtain a published service, the requesting application sends a method call to the system as a Simple Object Access Protocol (SOAP) message. The SOAP message includes an XML method call which conforms to the required structure and parameters. So long as each system can build and interpret the SOAP message, no compatibility between the two systems is required.

Web services enable applications to be written which request data from the web service providers. For example, a web server which provides stock quotes may publish the structure and parameters for requesting a stock quote, the method call may be required to include the ticker symbol corresponding to the requested quote. The web server system provides the information to the requesting application in response to receiving such a method call.

The use of web service systems for transferring transaction data between two applications has at least two problems.

First, each of the two applications must be configured to manage the exchange of XML messages at the application level. For example, the client application must be configured with the appropriate information for contacting the web services server and the two applications must be appropriately configured for handling the timing of the transaction transfer and appropriate acknowledgments.

Secondly, web service technology is a transport technology that does not include any inherent security. The transfer of method calls using web services can be secured only if the applications include means for mutual authentication and means for encrypting the messages.

What is needed is a system and method for secure document delivery to a remote location that does not suffer the disadvantages of the known system. More specifically, what is needed is a system and method for the secure transport of a transaction document to a remote system.

### SUMMARY OF THE INVENTION

A first aspect of the present invention is to provide a system for generating a document at a print system under the control of a remote client. The system comprises a document image template and a print command object.

The document image template comprises a document image and a plurality of data fields. The print command file creation module: i) receives a content message, the content message comprising a plurality of data elements; ii) creates a print command file which includes data and print system commands representing the document image template with the data fields populated with data elements from the content message; and iii) provides a binary object representing the encrypted print file to the remote client.

A print control executable operates on the remote client. The print control executable receives the binary object into volatile memory and passes the print command file to a print system for document generation. The print system may be a print spooler coupled to a printer for generating a hard copy of the document or a virtual print application (such as Acrobat® writer from Adobe Systems) for generating a portable document file.

The content message may be a textual message compliant with an extensible mark-up language schema. A predetermined textual data tag may associate with each data element for purposes of identifying the data element.

The binary object may be packaged within a multipart transport message. The multipart transport message may comprise a text string identifying a portion of the message representing the binary object as a print command file (or encrypted print command file).

The print command object may further encrypt the print command file to produce an encrypted print command file. In which case: i) providing the binary object to the remote client comprises providing the encrypted print file to the remote client; and ii) the print control executable further comprises an embedded encryption key and a decryption module which uses the encryption key to decipher the encrypted print file to recover the print file into volatile memory.

The system may comprise a plurality of document image templates—each associating with a document image template. The content message may include a template identifier identifying a one of a plurality of document image templates into which the data elements of the content message populate. In which case, the print command object creates the print command file by populating the data fields of the document image template, identified by the template identifier, by mapping data elements from the content message to the data fields.

For a better understanding of the present invention, together with other and further aspects thereof, reference is made to the following description, taken in conjunction with the accompanying drawings, and its scope will be pointed out in the appended claims.

### BRIEF DESCRIPTION OF THE DRAWINGS

FIG. 1 is a block diagram of a system for secure printing of a transaction document at a remote location in accordance with one embodiment of the present invention;

FIG. 2 is diagram representing an exemplary document template in accordance with one embodiment of the present invention;

FIG. 3 is a block diagram of an exemplary implementation of a system for secure printing of a transaction document at a remote location in accordance with an embodiment of the present invention;

FIG. 4 is a diagram representing an exemplary content message in accordance with one embodiment of the present invention;

FIG. 5 is a table representing an exemplary mapping file in accordance with one embodiment of the present invention;

FIG. 6 is a ladder diagram representing operation of a system for secure printing of a transaction document at a remote location in accordance with one embodiment of the present invention;

FIG. 7 is a block diagram of an exemplary implementation of a system for secure printing of a transaction document at a remote location in accordance with an embodiment of the present invention;

FIG. 8 is a ladder diagram representing operation of a system for secure printing of a transaction document at a remote location in accordance with one embodiment of the present invention;

FIG. 9 is a diagram representing an exemplary web page for user selection of a document batch for printing in accordance with one embodiment of the present invention; and

FIG. 10 is flow chart representing exemplary operation of a print control executable in accordance with one embodiment of the present invention;

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

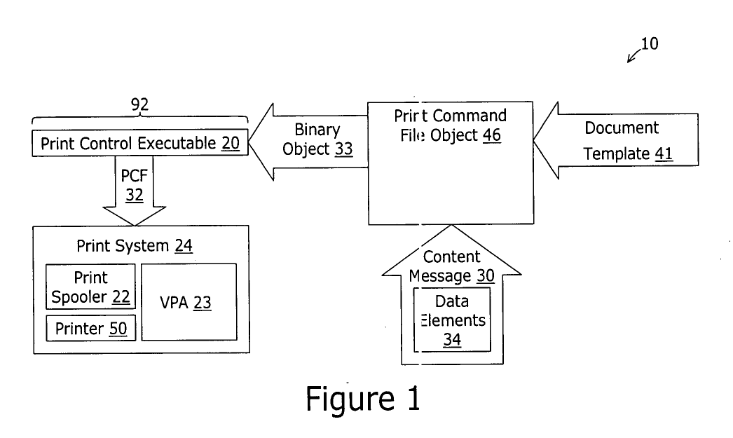

FIG. 1 illustrates exemplary architecture of system 10 providing secure transaction document printing services at a remote print system 24. The system 10 comprises a print command object 46 and a print control executable 20.

The print command object 46: i) receives a content message 30 comprising a plurality of data elements 34 from a data source; ii) obtains a document image template 41 which corresponds to the data elements 34 of the content message 30; iii) populates the data elements 34 into fields of the document image template 41 to generate a print formatted object (e.g. a print command file) 32; and ii) provides a binary object 33 representing the print command file 32 to the print control executable 20.

The document image template 41 comprises a plurality of data fields and a document pattern which defines the relative position for printing of each data field within the document and may further comprise information such as: i) the font and size of each data field; ii) formatting of data for each data field (for example leading and/or trailing characters; and iii) algorithms for generating data for a particular data field from data of other data fields.

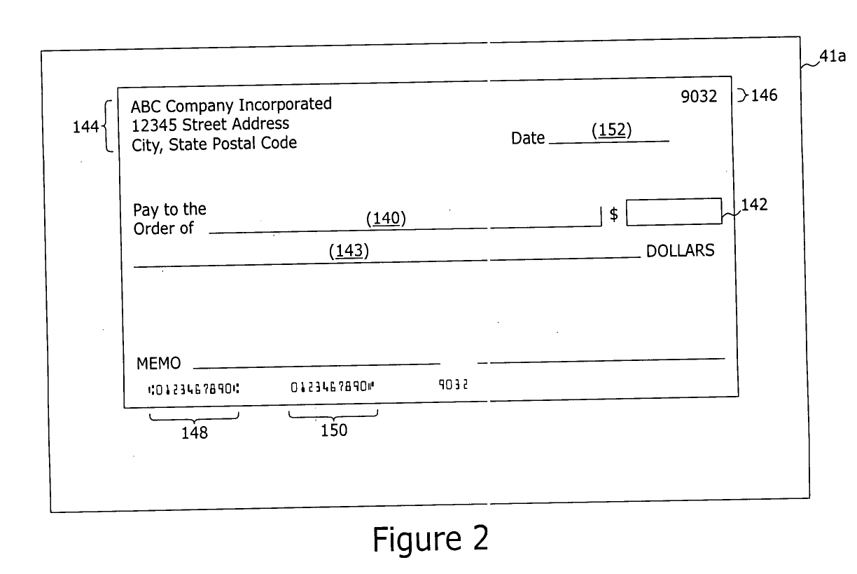

Turning briefly to FIG. 2 an exemplary document image template 41a representing a typical check is shown in a graphic form. Some of the data fields of the check document image template 41a comprise: i) a check number field 146; ii) a date field 152; iii) payer fields 144 (name, address, etc); iv) payee field 140; v) an amount field 142; vi) a legal line field 143 for a script representation of the amount generated from data within amount field 142; vii) a routing number field 148 (designated for printing in MICR font); and viii) an account number field 150 (designated for printing in MICR font). It should be appreciated that a check document may comprise many additional fields, but for brevity of describing an example of the present invention, only the above listed fields will be described.

Returning to FIG. 1, the print control executable 20 operates on a remote client 92 (such as a PC) which includes, or is coupled to, the print system 24. The print system 24 may be a print spooler 22 and a printer 50 or a virtual print application 23 such as Acrobat PDF Writer® available from Adobe Systems.

The print control executable 20 receives a binary object 33 representing the print command file 32 into volatile memory of the remote system and passes the print command file 32 to the print system 24. It should be appreciated that by receiving the print command file 32 into volatile memory only, no non-volatile record of the print command file 32 is written to a hard drive or other non-volatile storage thereby reducing the ability to intentionally (or unintentionally) printing the document a second time.

### First Implementation Embodiment

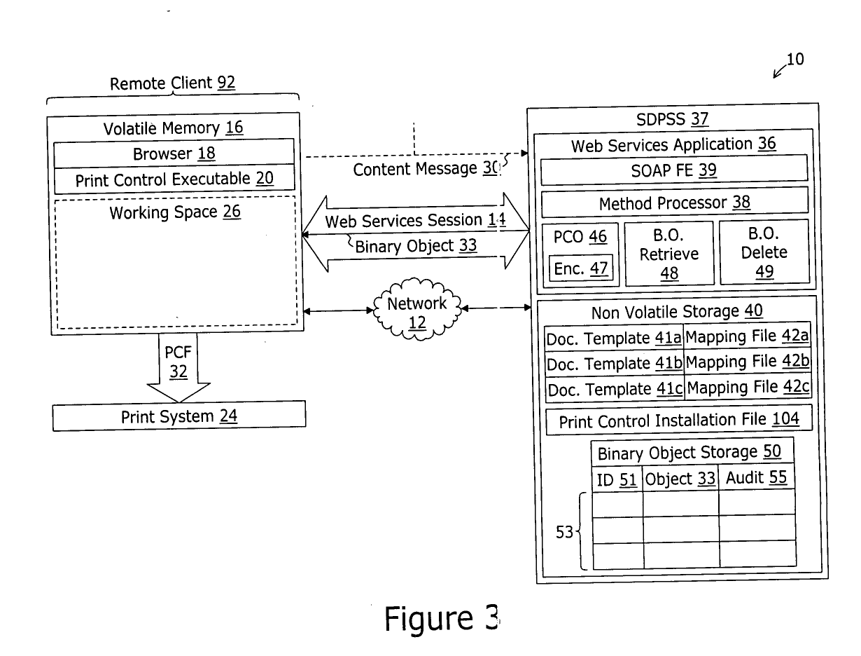

The block diagram of FIG. 3 represents in implementation of the system 10 for secure transaction document printing servers wherein: i) the print control executable 20 is a browser plug-in operating on a remote client system 92 and the print command object 46 is implemented in a web services application 36 of a secure document printing services server 37.

In this implementation, the remote client system 92 is communicatively coupled to the secure dorcument printing services server 37 through data communications network 12. The data communications network 12 may be IP compliant network(s) such as the Internet or a combination of the Internet and various subnets or local area networks coupled to the Internet.

The remote client system 92 may be embodied on one or more computer systems and includes a processor executing code from a volatile memory 16. In the exemplary embodiment the code executed from volatile memory 16 includes: i) a client application 18 such as a web browser (e.g. web browser 18); and ii) the print control executable 20 which may be a component of, an extension to, or a plug in to, the web browser 18. Other code may include an operating system, network systems, other lower level systems and all or a portion of the print system 24 (such as the print spooler 22 and/or the virtual print application 23).

As is known in computer architecture, in addition to storing executable code, the volatile memory 16 stores data being manipulated by the executable code. Working space 26 represents the “address space” of the volatile memory 16 used for storing data being manipulated by the executable code.

The secure document printing services server 37 may be embodied on one or more computer systems and exchanges data with the client application 18 of the client system 92 through a web services session 14 established over the network 12. The secure document printing services server 37 comprises a web services application 36 and non volatile storage 40.

The web services application 36 may include a simple object access protocol (SOAP) front end 39 which utilizes the SOAP for exchanging data messages, as SOAP objects, with remote systems. In particular, the web services application 36 may receive the content message 30 as a SOAP object from a data source (which may or may not be the remote client 92) and provide the binary object 33 to the print control executable 20 of the remote client 92 as a component of a multipart transport message including a SOAP object and the binary object 33. The multipart transport message may comply with the MIME protocol and include the SOAP object within the root body part and include a predetermined text string identifying the type of file represented by the binary object 33.

The content message 30 is a text file which includes the data elements 34. Each data element 34 is identified by a data tag of a predetermined character string. The predetermined character sting maps to one of the data fields of the document template (for example the check document template 41a of FIG. 2). At least one data element 34 may identify a one of a plurality of (or multiple) document templates 41a-41c into which the date elements 34 of the content message 30 populate.

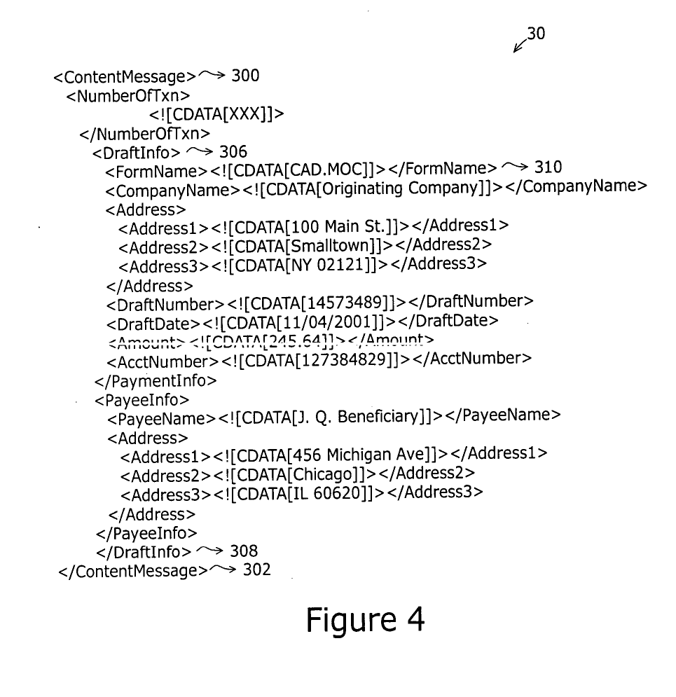

Turning briefly to FIG. 4, a portion of an exemplary content message 30, with data elements 34 which populate into the exemplary check document template 41a, is shown. The content message 30 is a text file which includes nested tagged data in a typical XML schema. Each data element 34 is identified by a predefined character string.

The predefined character string <ContentMessage> 300 and </Content Message> 302 functions as the highest nesting layer indicating the start and stop of the content message 30.

A content message 30 may include multiple groupings of data elements 34, each of such grouping populating into a particular document template (such a check document template 41a) or into multiple different document templates. Each of such groupings may be referred to as a transaction and the quantity of transactions within a content message 30 may be represented by a data element 34 identified by the predetermined character string <NumberOfTxn> 304.

The data elements 34 between <DraftInfo> 306 and </DraftInfo> 308 populate into a document template (such as the check document template 41) which corresponds to the data element indicated by predefined character string <FormName> 310. It should be appreciated: i) many additional data elements 34 (and nested groupings of data elements) may be included within DraftInfo—the data elements 34 shown in FIG. 4 are exemplary only.

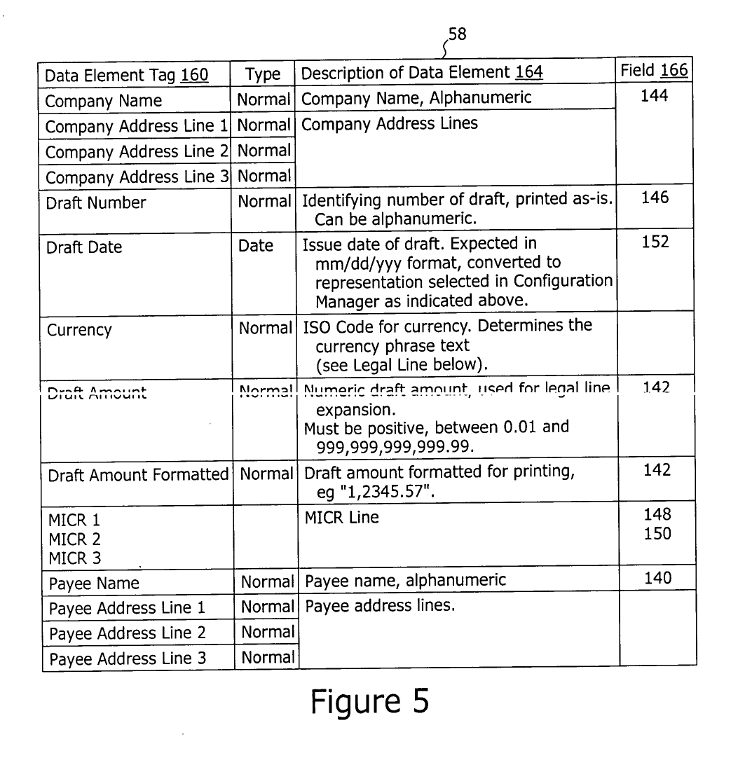

Turning briefly to FIG. 5, a mapping table 58 representing the mapping of the data elements 34 of FIG. 4 into the data fields of the document template 41a of FIG. 2 is shown. The table 58 includes a plurality of records, each record associating with a data element tag 160 of the content message 30 and indicating to which field 166 of the document image template 41a the data is to be written and a description of the data element which may include: i) the font in which the data is to be written into the document template 41a; ii) a data format (including leading or trailing characters); and/or iii) a conversion that is to be performed before writing to the document image template—such as currency conversion or numeric to text conversion for the legal line 143 (FIG. 2).

Returning to FIG. 3, a method processor 38 of the web services application 36 routes XML messages, representing web services method calls and responses, between the SOAP front end 39 and various method or objects which, in this implementation include the print command object 46, a binary object (BLOB) retrieve object 48, and a BLOB delete object 49.

The non volatile storage 40 comprises a plurality of document templates 41a-41c, a plurality of mapping files 42, the print control installation file 104, and binary object storage 50. The binary object storage 50 is represented as a table which includes a plurality of records 53. Each record 53 stores, in association with a unique identifier 51, a binary object 52.

In general, the print command object 46 operates as discussed with respect to FIG. 1. In more detail and with respect to the present implementation, the print command object 46 may receive the content message 30 as an XML message and, in response thereto: i) retrieve a document image template 41 and a mapping file 42 which correspond to the data elements 34 of the content message 30; ii) use the mapping file 42 to map data elements 34 from the content message 30 to data fields of the document image template 41 to build a printable image of the document (for example the check as shown in FIG. 2); and iii) generate a print command file 32 (such as Post Script, Printer Command Language, or other print formatted object which includes objects, fonts, and/or graphics in a format useful by the printer system 24) for generating a hard copy document (or portable document file) representing the image document.

Further, an encryption object 47 of the print command object 46 (or coupled to the print command object 46) may encrypt the print command file 32 using a predetermined cipher specification (e.g. a predetermined encryption algorithm and key) to generate an encrypted representation of the print command file 32.

The encrypted representation of the print command file 32 may be: i) packaged as a binary object 33 within a multipart transport message (that includes both a SOAP object in the root body part and the binary object 33) for delivery to the print control executable 20; or ii) stored as a binary object 33 in association with a unique identifier 51 within binary object storage 50. In such case, the unique identifier is provided to the remote client 92 such that the binary object 33 may be retrieved and delivered to the print control executable 20 of the remote client 92 at a later time.

In general, the BLOB retrieve object 48 operates on an XML content message which includes a unique ID number 51 previously used for identifying a binary object 33 within the binary object storage 50. The BLOB retrieve object 48 obtains the binary object 33 stored in association with the unique ID number 51 and packages the binary object 33 within a multipart transport message for delivery to the print control executable 20.

The BLOB retrieve object 48 may also write applicable data to an audit log 55 identifying the remote system 92(or the authenticated user of the system) which made the BLOB retrieve method call, the time of the BLOB retrieve method call, and an indication that the binary object 33 was successfully returned.

In general, the BLOB delete object 49 operates on an XML content message which includes a unique ID number 51 previously used for identifying a binary object 33 stored in the binary object storage 50. The BLOB delete object 48 deletes the binary object 33 (stored in association with the unique ID number 51) from the binary storage 50 and may return an indicator of confirmation as a tagged data element of an XML message.

The BLOB delete object may also write applicable data to the audit log 55 identifying the remote client 92 (or the authenticated user of the remote client 92) which made the BLOB delete method call, the time of the BLOB delete method call, and an indication that the binary object 33 was successfully deleted.

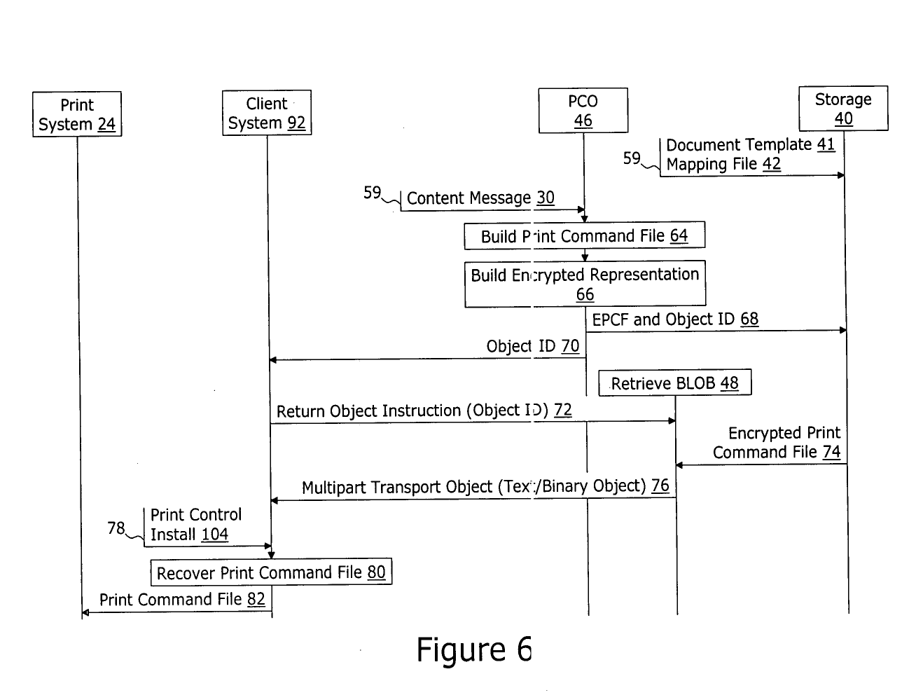

The ladder diagram of FIG. 6 represents exemplary operation of the components of the system of FIG. 3 for providing secure transaction document printing services at a print system 24 under control of the remote client 92.

Referring to FIG. 6 in conjunction with FIG. 3, step 59 represents loading at least one document template 41 and the at least one mapping file 42 to the non volatile storage 40 of the secure document printing services server 37.

More specifically, an administrator workstation coupled to the network 12 includes a communication application (such as a web browser with file transfer capabilities), a layout design tool, and a configuration tool. Loading at least one document template 41 and at least one mapping file 42 may comprise the administrator workstation establishing a connection to the secure document printing services server 37 (such as an HTTPS connection or a secure FTP connection) and transferring a file representing a document image template 41 (created by the layout design tool) and transferring a mapping file 42 (created by the configuration tool).

Step 60 represents transfer of a content message 30 to the print control object 46. As discussed, the content message 30 may be a plain text SOAP object representing a web services method call and including data elements 34 identified by predetermined and nested text data tags in conformance with an extensible mark-up language protocol.

The content message 30 may be provided by the client system 92 or by any other system operated by a user with entitlements for selecting and approving documents for printing and providing the content message 30 to the secure document printing services server 37.

Step 64 represents the print control object 46 building a print command file 32. Upon receipt of the content message 30 the message processor 38 recognizes the content message 30 as a method call to the print command object 46 and passes the content message 30 to the print command object 46.

As discussed, the print command object 46: i) retrieves a document image template 41 and a mapping file 42 from the non volatile memory 40; ii) uses the mapping file 42 to map data elements 34 from the content message 30 to data fields of the document image template 41 to build a printable image of the document such as a check or other negotiable instrument; and iii) generates a print command file 32 (such as Post Script, Printer Command Language, or other print formatted object which includes objects, fonts, and/or graphics in a format useful by the print system 24 for generating the document.

The print command object 46: i) at step 66, encrypts the print command file 32 (via the encryption object 47) to generate an encrypted representation of the print command file 32; ii) at step 68, stores the encrypted representation of the print command file 32 as a binary object 33 in association with a unique ID number 51 in binary object storage 50 of the non-volatile memory 40; and iii) returns the unique ID number 51 (as a tagged data element of an XML message) to the message processor 38 for return to the calling system at step 70.

Step 72 represents the browser 18 of the remote client 92 making a retrieve BLOB method call to the BLOB retrieval object 48 of the secure document printing services server 37. As discussed, the retrieve BLOB method call may be a SOAP object which includes, as a tagged data element, the unique identification number 51 associated with a binary object 33 stored in the binary storage 50.

Step 74 represents retrieval of the binary object 33 which corresponds to the unique identification number 51 from the binary storage 50. As discussed, upon receipt of the retrieve BLOB message, the method processor 38, recognizes the message as a method call to the retrieve BLOB object 48 and passes the document message to the 10 retrieve BLOB object 48.

Step 76 represents the retrieve BLOB object 48 returning the binary object 33 to browser 18 as a component of a multipart transport message that includes both a SOAP object within a root body part and the binary object 33.

As discussed, the print control executable 20 (which may be a component of, an extension of, or a plug in to the browser 18): i) deciphers the encrypted representation of the print command file 32 of the binary object 33 to recover the print command file 32 at step 80; and ii) at step 82, passes the recovered print command file 32 to the print system 24 (e.g. the print spooler 22 or the or the virtual print application 23 for printing or saving as a portable document file respectively).

If a binary object 33 (including an encrypted representation of a print command file 32) is received and the print control executable 20 is not yet installed on the remote client 92, a print control install file 104 may be provided to the remote client 92 and the user prompted to download and install the print control installation file 104 in the manner typically for downloading and installing “browser plug-ins”. Step 78 represents downloading and installation of the print control installation file 104 (if not previously installed on the remote workstation 22).

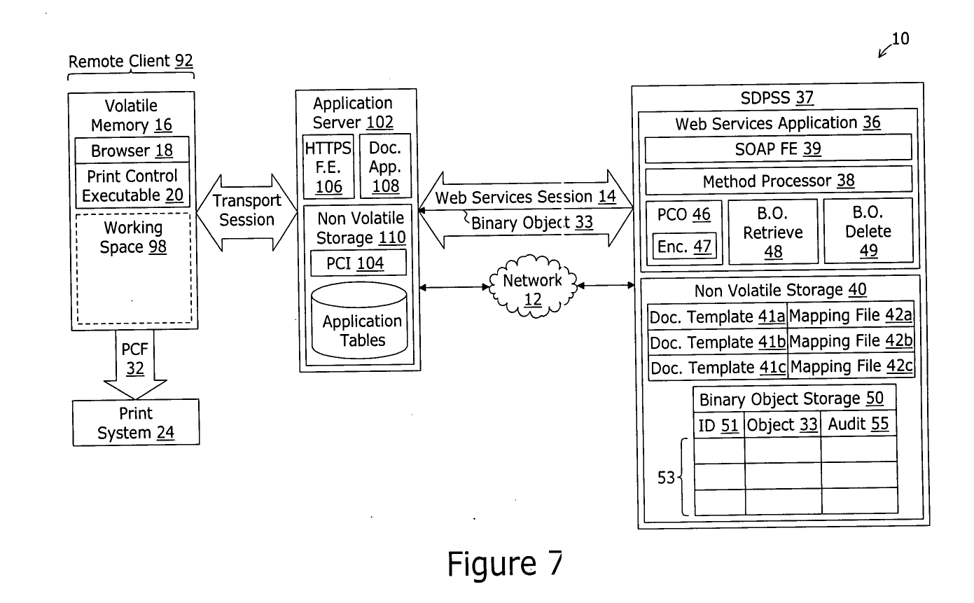

The block diagram of FIG. 7 represents an alternative architecture of system 10 providing secure transaction document printing services at a remote client 92.

In the alternative embodiment, the system 10 comprises an application server 102 and the secure document printing services server 37 which communicate over a web services session 14 established over a network.

In this embodiment, the secure document printing services server 37 and each of its components operates as discusses with respect to the block diagram of FIG. 3 and the ladder diagram of FIG. 6.

In general, the application server 102 interfaces between the remote client 92 and the secure document printing services server 37. The application server 102 may be structured as a known HTTPS web server which includes a known HTTPS front end 106 for establishing and maintaining an HTTPS session with a remote browser (such as client application 18 on the remote client 92). A document application 108 which includes web server functions for driving the functionality of the “thin client” browser based remote client 92 and web services client functions for interfacing with the secure document printing services server 37. A non-volatile storage 110 stores document application tables 319 and a print control executable file 104.

In the exemplary embodiment, the document application 108 is a menu driven application which interacts with the application tables 319 and, in general, provides sequences of web pages to a remote browser thereby enabling a user to authenticate to the document application 108 and navigate menus to execute functions within the user's entitlements. Such functions may include: i) loading document data representing a plurality of documents to be printed into a file within the application tables 319; ii) selecting and approving a one of a plurality of files stored in the application tables 319 for printing at a remote workstation 92 (by a user with document approval entitlements); iii) initiating appropriate web services method calls to the secure document printing services server 37 to transfer a content message 30 representing the selected and approved file to the secure document printing services server 37; iv) obtaining, from the secure document printing services server 37, a unique ID number associated with the binary object 33 generated by the print command object 46 of the secure document printing services server 37; v) selecting a one of a plurality of binary objects 33 for printing at the remote workstation 92 (by a user with document printing entitlement); vi) generating a BLOB retrieve web services method call to the secure document printing services server 37 including the unique ID number 51 of the selected binary object 33 and obtaining the binary object 33 in response thereto; and vii) transferring the binary object 33 to the remote client 92 through the HTTPS session there with for deciphering by the print control executable 20. Further, if a print control executable 20 has not yet been installed on the remote workstation 22, providing the print control installation file 104 to the remote workstation 92.

It should be appreciated that in FIG. 7 the application server 102 and the secure document printing services server 37 are shown as distinct servers communicating through a web services session 14 established over a network 12. It is envisioned that the functions of both the application server 102 and the secure document printing services server 37 may be combined on a single hardware server or on multiple hardware servers operating in conjunction with a single database environment. The single database environment may combine, in a single database, the functions of both the non volatile storage 40 of the secure document printing services server 37 and the non volatile storage 110 of the application server 102.

The remote client 92 includes structure and functions similar to those discussed with respect to FIG. 3 and FIG. 6 with the exception that the browser 18 maintains a secure transport connection (such as HTTPS) with the application server 102 instead of interfacing with the secure document printing services server 37 directly using web service method calls and responses.

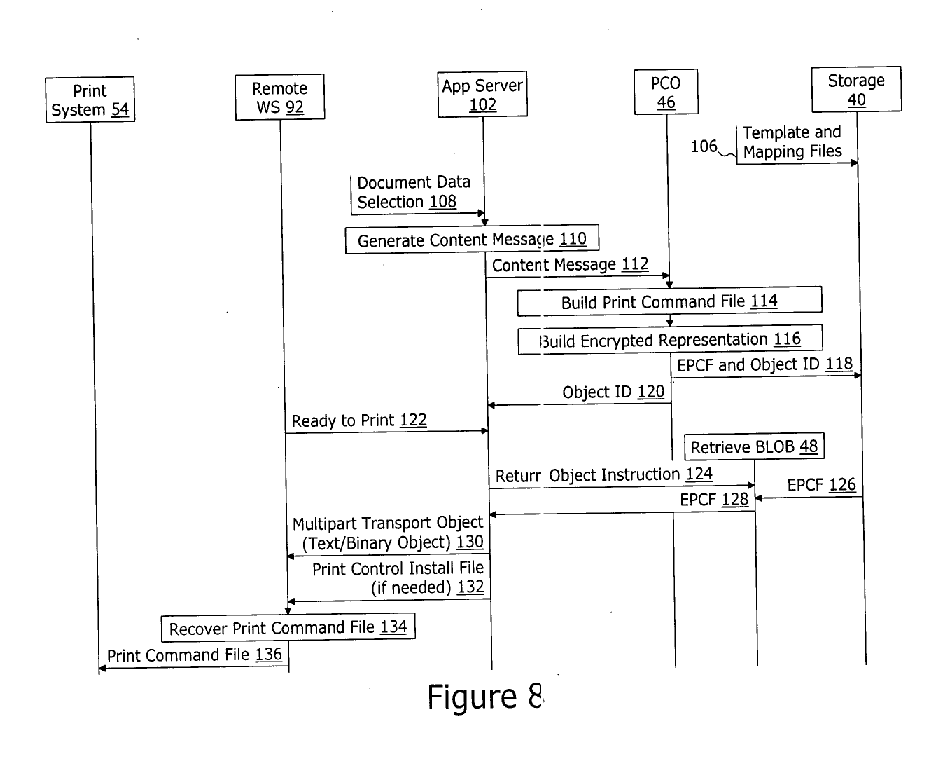

FIG. 8 is a ladder diagram representing exemplary interaction between the remote workstation 92, the application server 102, and the secure document printing services server 37 for providing secure document printing services at the remote workstation 22 in accordance with this embodiment.

Step 106 represents loading at least one document template 41 and at least one mapping file 42 to the non volatile storage 40 of the secure document printing services server 37 in manner as previously discussed with respect to step 59 of the ladder diagram of FIG. 6.

Step 108 represents selection of document data for inclusion in a content message 30. In the exemplary embodiment, a secure connection may be established between any thin client workstation (including workstation 92), the user of the workstation authenticating to the document application 108 and having document approval entitlements, and such entitled user selecting documents for inclusion in the content message 30.

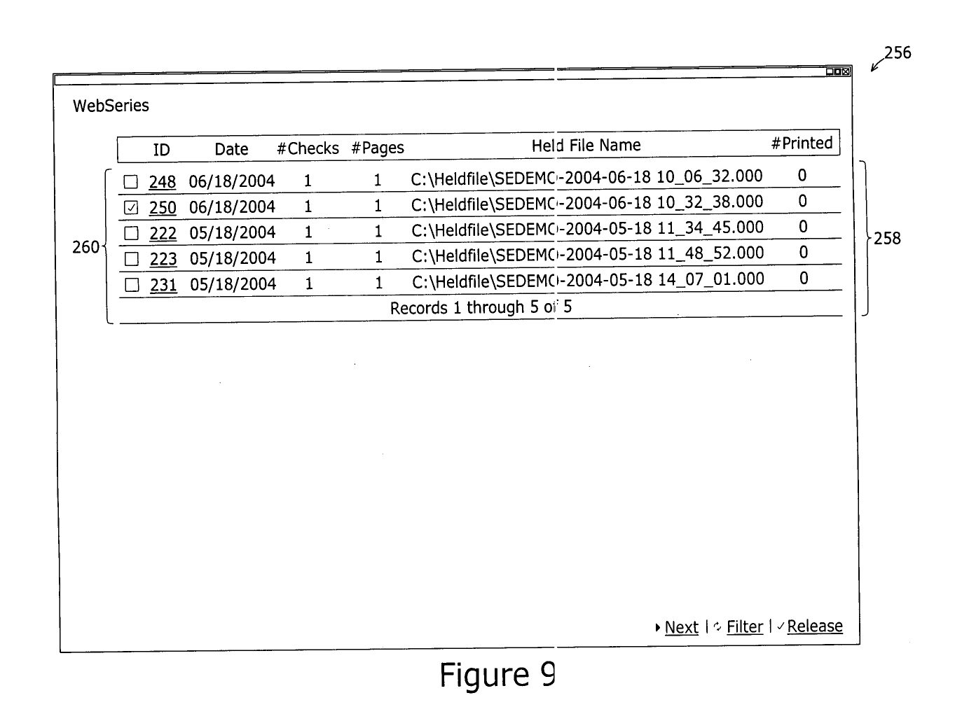

FIG. 9 represents an exemplary web page 256 that the document application 108 may provide to a thin client to enable the user of the thin client to select a one of a plurality of document files (a file containing data elements 34 for inclusion in a content message 30) The web page 256 includes a listing 258 of those document files which the user of the thin client is authorized to approve for printing. In this example, the user would toggle a check box 260 for each approved file. The web page 256 further includes code for transferring an indication of the user's selection back to the document application 43.

Returning to the ladder diagram of FIG. 8 in conjunction with FIG. 7, step 110 represents the document application 108 generating the content message 30. More specifically, step 110 represents extracting the data elements 34 of the document data file corresponding to the user's selection from the application tables 319, converting the document data to tagged data elements conforming to the a predetermined XML content message schema, and packaging the XML message as a SOAP content message 30.

Step 112 represents passing the content message 30 to the secure document printing services server 37 as a web services method call.

Step 114 and step 116 represents building a print command file 32 and encrypting the print command file 32 to generate an encrypted representation as previously discussed with respect to steps 64 and 66 of the ladder diagram of FIG. 6 respectively.

Step 118 represents storing the encrypted representation of print command file 32 as a binary object 33 in association with a unique identification number 51 in the binary object storage 50.

Step 120 returning the unique ID number 51 (as a tagged data element of an XML message) to the application server 102.

Step 122 represents the application server 102 obtaining an indication that the user of the remote client 92 (with document printing entitlements) is ready to print the selected documents. This may include establishing a secure connection between the remote client 92 and the application server 102, after authenticating the user of the remote workstation 92, providing web pages to the remote client 92 which includes content to enable the user to select an option to print documents.

Step 124 represents the application server 102 passing a return binary object web services method call (including the unique ID number 51 associated with the binary object 33 representing the selected documents) to the secure document printing services server 37.

Step 126 represents the BLOB retrieval object 48 extracting, from the binary object storage 50, the binary object 33 that associates with the unique identifier 51 included in the method call.

Step 128 represents retuning such binary object 33 as a component of a multipart transport message sent in response to the method call—as previously discussed with respect to steps 74 and 76 of the ladder diagram of FIG. 6 respectively.

Step 130 represents the application server 102 passing the binary object 33 to the browser 28 of the remote client 22 through the secure transport session established therewith.

As discussed, the print control executable 20 (which may be a component of, an extension of, or a plug in to the browser 18): i) deciphers the encrypted representation of the print command file 32 to recover the print command file 32 at step 134; and ii) at step 136, passes the recovered print command file 32 to the print system 24 (e.g. the print spooler 22 or the or the virtual print application 23 for document generation.

As discussed with respect to the ladder diagram of FIG. 6, if a binary object 33 representing an encrypted print command file 32 is received and the print control executable 20 is not yet installed on the remote client 92, a print control install file 104 may be provided to the remote client 22 and the user prompted to download and install the print control executable 20 in the manner typically for downloading and installing “browser plug-ins”. Step 132 represents downloading and installation of the print control installation file 104 (if not previously installed on the remote workstation 92).

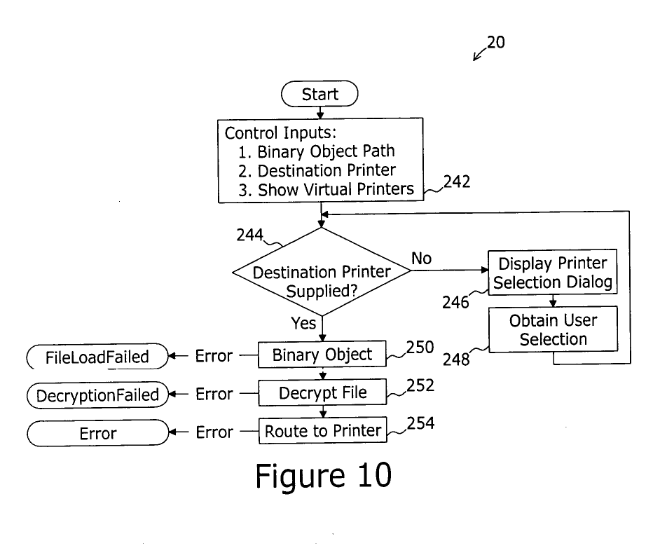

The flow chart of FIG. 10 represents exemplary operation of a print control executable 20. The input information used for launching execution of the print control executable includes a path to the binary object 33 provided to the browser 18, and an indication of the destination printer 50 (or virtual print application 23). Step 242 represents obtaining such input information when supplied.

If the destination printer information is not supplied, as represented by step 244, the indication of the destination printer 50 (or virtual print application 23) may be obtained by opening a printer selection dialog window at step 246 and obtaining user selection at step 248.

Step 250 represents loading the binary object 33 into volatile memory, step 252 represents performing decryption of the print command file 32 represented by the binary object 33 using a pre-determined cipher specification (e.g. a predetermined cipher algorithm and key which may be pre-coded into the print control executable 20) to recover the print command file 32, and step 254 represents passing the print command file 32 to the selected printer. If at any of such steps, loading, decryption, or printing fails, an applicable error message is generated.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of the system of the present invention. The present invention includes all such equivalents and modifications, and is limited only by the scope of the following claims.

What is claimed is:

1. A system for generating a document at a print system under the control of a remote client, the system comprising:
a document image template, the document template comprising a document image and a plurality of data fields;
a print command object for:
receiving a content message, the content message comprising a plurality of data elements;
creating a binary object representing a print command file, the print command file including data and print system commands representing the document image template with the data fields populated with data elements from the content message;
providing the binary object to the remote client; and
a print control executable operating on the remote client, the control executable receiving the binary object into volatile memory and passing the print command file to the print system for document generation.

2. The system of claim 1, wherein the binary object is packaged within a multipart message, the multipart message comprising a text string identifying a portion of the multipart message representing the binary object as a print command file.

3. The system of claim 2, wherein the content message is a text file and wherein:
at least one data element identifies a one of a plurality of document image templates into which the data elements of the content message populate; and
each data element is identified by a data tag of a predetermined character string, the predetermined character string mapping to one of the data fields of the identified one of the plurality of document image templates.

4. The system of claim 3, wherein:
the system further comprises an print control installation file, the print control installation file including instructions for installing the print control executable on the remote client, and
the system provides the print control installation file to the remote client.

5. The system of claim 1, wherein:
wherein the print command object further comprises an encryption object for encrypting the print command file to provide an encrypted representation of the print command file;
the binary object includes the encrypted representation of the print command file; and
the print control executable further deciphers the encrypted representation of the print command file to recover the print command file.

6. The system of claim 5, wherein:
the encryption module encrypts the print command file to provide an encrypted representation of the print command file by applying a predetermined ciphering specification to the print command file, and
the predetermined ciphering specification corresponds to a predetermined deciphering specification performed by the print control executable whereby the print control executable may decipher the encrypted representation of the print command field to recover the print command file by applying the predetermined deciphering specification to the encrypted representation of the print command file.

7. The system of claim 6, wherein the binary object is packaged within a multipart message, the multipart message comprising a text string identifying a portion of the multipart message representing the binary object as an encrypted print command file.

8. The system of claim 7, wherein the content message is a text file and wherein:
at least one data element identifies a one of a plurality of document image templates into which the data elements of the content message populate; and
each data element is identified by a data tag of a predetermined character string, the predetermined character string mapping to one of the data fields of the identified one of the plurality of document image templates.

9. The system of claim 8, wherein:
the system further comprises an print control installation file, the print control installation file including instructions for installing the print control executable on the remote client, and
the system provides the print control installation file to the remote client.

10. A method for generating a document at a print system under the control of a remote client, the method comprising:
receiving a content message, the content message comprising a plurality of data elements;
retrieving, from a non volatile storage, a document image template, the document template comprising a document image and a plurality of data fields;
creating a print command file which includes data and print system commands representing the document image template with the data fields populated with data elements from the content message;
providing a binary object binary command file into a volatile memory of the remote client and passing the print command file to the print system for document generation.

11. The method of claim 10, wherein the binary object is packaged within a multipart message, the multipart message comprising a text string identifying a portion of the multipart message representing the binary object as a print command file.

12. The method of claim 11, wherein the content message is a text file and wherein:
at least one data element identifies a one of a plurality of document image templates into which the data elements of the content message populate; and
each data element is identified by a data tag of a predetermined character string, the predetermined character string mapping to one of the data fields of the identified one of the plurality of document image templates.

13. The method of claim 12, further comprising providing a print control installation file to the remote client, the print control installation including instructions for installing the print control executable on the remote client.

14. The method of claim 10, further comprising encrypting the print command file to provide an encrypted representation of the print command file; and wherein
the binary object includes the encrypted representation of the print command file; and
the step of passing the print command file to the print system for document generation includes deciphering the encrypted representation of the print command file to recover the print command file.

15. The method of claim 14, wherein:
encrypting the print command file to provide an encrypted representation of the print command file comprises applying a predetermined ciphering specification to the print command file, and
deciphering the encrypted representation of the print command file to recover the print command file comprises applying a predetermined deciphering specification to the encrypted representation of the print command file;
the predetermined ciphering specification corresponding to the predetermined deciphering specification.

16. The method of claim 15, wherein the binary object is packaged within a multipart message, the multipart message comprising a text string identifying a portion of the multipart message representing the binary object as an encrypted print command file.

17. The system of claim 16, wherein the content message is a text file and wherein:
at least one data element identifies a one of a plurality of document image templates into which the data elements of the content message populate; and
each data element is identified by a data tag of a predetermined character string, the predetermined character string mapping to one of the data fields of the identified one of the plurality of document image templates.

18. The method of claim 17, further comprising providing a print control installation file to the remote client, the print control installation including instructions for installing the print control executable on the remote client.
